(19) United States
(12) Patent Application Publication
(10) Pub. No.: US 2026/0148158 A1
(43) Pub. Date: May 28, 2026

(54) FINISHED VEHICLE ACCESSORY INSTALLATION ON-DEMAND CONVEYANCE SYSTEMS AND METHODS

(71) Applicant: Toyota Motor North America, Inc., Plano, TX (US)

(72) Inventors: Nick S. Wu, Frisco, TX (US); Anthony D. Sanor, Melissa, TX (US); Ming-Tsu Wang, Little Elm, TX (US); Jaclyn Kowalski, Denver, CO (US); Doug R. Sowers, Oak Point, TX (US); Gomathisankar Rajendran, Irving, TX (US); Robert Stelling, Allen, TX (US)

(73) Assignees: Toyoto Motor North America, Inc., Plano, TX (US); Toyoto Jidosha Kabushiki Kaisha, Aichi-ken (JP)

(21) Appl. No.: 18/957,128

(22) Filed: Nov. 22, 2024

(51) Int. Cl. G06Q 10/0631; G06Q 10/0633; G06Q 10/0639; G06Q 10/087

(52) U.S. Cl. CPC G06Q 10/06315; G06Q 10/0633; G06Q 10/06393; G06Q 10/087

(57) ABSTRACT

A method for vehicle accessory installation comprises generating a mixed model workflow plan for feeding vehicles into one or more accessory installation locations; determining at least one instance of a deviation from the mixed model workflow plan, wherein the deviation negatively impacts a production demand for a first timeframe; identifying, in real-time based on the occurrence of the deviation, at least one of vehicle distributed across a staging lot to feed into at least one of the one or more accessory installation locations; allocating a pull order corresponding to at least one identified vehicle to a puller based on a performance metric of the puller; and transmitting the pull order to a puller device to retrieve the one or more vehicles, wherein the pull order comprises a location of the vehicle and a time to deliver the vehicle to a staging location for the one or more accessory installation locations.

### TECHNICAL FIELD

The present specification generally relates to vehicle accessory assembly, and more particularly to systems and methods for production sequencing of vehicle accessory installation on finished vehicles.

### BACKGROUND

Variations in vehicle configurations (e.g., vehicle variants, such as trims and accessories) can create challenges for a build-to-stock approach to production sequencing. For example, because a number of different options or accessories may be available for each vehicle type, and these options may be purchased not only in grouped packages but also individually, some vehicle models may include hundreds, thousands, or more combinatorial variants. From the time an order is placed, a fully accessorized vehicle can take several months to be delivered to the end customers, with the largest contributor to such delay often being the queuing time at a vehicle accessory installation center.

Typically, once a vehicle is scheduled for accessory installation, it is parked outside the accessory installation center in a parking lot with other scheduled vehicles, which are brought in for accessory installation in either a first-in-first-out order, or hot calls from post-production accessory installation lines. However, these simple queuing strategies often result in “unrouteable” steps, e.g., steps which cannot be completed before the end of the current work shift. Such unrouteable steps tie up space, equipment, and personnel, and are thus a primary driver of queueing delays.

Therefore, a need exists for systems and methods that offer improved vehicle accessory installation on finished vehicles.

### SUMMARY

In some embodiments, a method for vehicle accessory installation comprises: generating a mixed model workflow plan for feeding a plurality of vehicles into one or more accessory installation locations; determining at least one instance of a deviation from the mixed model workflow plan, wherein the deviation negatively impacts a production demand for a first timeframe; identifying, in real-time based on the occurrence of the deviation, at least one of one or more vehicles distributed across a staging lot to feed into at least one of the one or more accessory installation locations; allocating a pull order corresponding to at least one identified vehicle of the one or more vehicles to a puller based on a performance metric of the puller; and transmitting the pull order to a puller device to retrieve the one or more vehicles, wherein the pull order comprises a location of the one or more vehicles and a time to deliver each of the one or more vehicles to a staging location for the one or more accessory installation locations.

In some embodiments, a system for vehicle accessory installation, the system comprises a processor; and a memory storing computer-executable instructions that, when executed by the processor, cause the system to: generate a mixed model workflow plan for feeding a plurality of vehicles into one or more accessory installation locations; determine at least one instance of a deviation from the mixed model workflow plan, wherein the deviation negatively impacts a production demand for a first timeframe; identify, in real-time based on the occurrence of the deviation, at least one of one or more vehicles distributed across a staging lot to feed into at least one of the one or more accessory installation locations; allocate a pull order corresponding to at least one identified vehicle of the one or more vehicles to a puller based on a performance metric of the puller; and transmit the pull order to a puller device to retrieve the one or more vehicles, wherein the pull order comprises a location of the one or more vehicles and a time to deliver each of the one or more vehicles to a staging location for the one or more accessory installation locations.

In some embodiments, a non-transitory computer-readable medium comprising processor-executable instructions that, when executed by one or more processors of an apparatus, causes the apparatus to perform a method comprising: generating a mixed model workflow plan for feeding a plurality of vehicles into one or more accessory installation locations, wherein the mixed model workflow plan is devised to achieve the production demand for a first timeframe; determining at least one instance of a deviation from the mixed model workflow plan, wherein the deviation negatively impacts a production demand for the first timeframe; identifying, in real-time based on the occurrence of the deviation, at least one of one or more vehicles distributed across a staging lot to feed into at least one of the one or more accessory installation locations; allocating a pull order corresponding to at least one identified vehicle of the one or more vehicles to a puller based on a performance metric of the puller; and transmitting the pull order to a puller device to retrieve the one or more vehicles, wherein the pull order comprises a location of the one or more vehicles and a time to deliver each of the one or more vehicles to a staging location for the one or more accessory installation locations.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals.

FIG. 1 depicts an illustrative system for vehicle accessory installation.

FIG. 2 depicts an illustrative computing device for vehicle accessory installation.

FIG. 3 depicts a diagrammatic representation of a production logistics process including the vehicle accessory installation process.

FIG. 4 depicts an illustrative flow diagram of a method for processing finished vehicles through the vehicle accessory installation process.

FIG. 5 depicts an illustrative block diagram of a demand management process for processing finished vehicles through the vehicle accessory installation process.

### DETAILED DESCRIPTION

Embodiments of the present disclosure are directed to systems and methods for processing finished vehicles through the vehicle accessory installation process. As used herein, the term “finished vehicles” refers to vehicles that require no further manufacturing operations to perform its intended function, but may be further accessorized to meet a customer's desired customization. Customization processes are typically performed before the vehicles reach the dealer.

When a vehicle is scheduled for installation of accessories chosen by a customer or dealership, the vehicle is brought to an accessory installation center and parked outside in a parking lot. Currently, vehicles may be processed in a first-in-first-out (FIFO) queuing order or hot calls from post-production accessory installation lines. However, when a production center includes a mix of cellular and assembly line production steps, these queuing strategies become a primary driver of delays and late deliveries. The vehicle accessory installation system of the present disclosure is directed to reduce queuing at the vehicle distribution centers, such as a vehicle accessory installation facility.

More specifically, embodiments provide techniques for orchestrating adjustments to a vehicle accessory installation workflow plan in real-time when a deviation from the workflow plan occurs. The techniques utilize elements of Heijunka, such as mix, leveling, and balance along with optimization and visual controls for human resource and delivery equipment. Implementation of embodiments described herein may result in an improvement in total output, the balance and leveling of production lines, full work for team members, and an increase in the total number of dealers serviced each day.

In certain embodiments, the process includes initiating a mixed-model workflow plan for feeding a plurality of vehicles into one or more accessory installation locations. As used herein, the one or more accessory installation locations may also be referred to as a post-production accessory installation line, a post-production accessory installation stall, or the like. A mixed-model assembly is a type of production system that produces several distinct products or models within one operation without decreasing productivity, efficiency, and quality. The mixed model workflow plan is devised to achieve a production demand for a first timeframe. The process continues with determining at least one instance of a deviation from the mixed model workflow plan. The deviation negatively impacts the production demand for the first timeframe. For example, the deviation may arise from a slow worker, broken equipment, change in demand, production delay, less human capital than in the plan, or the like.

In real-time the process may identify the occurrence of the deviation and in response identify at least one of one or more vehicles distributed across a staging lot to feed into at least one of the one or more accessory installation locations. The process of identifying the one or more vehicles is based on a distance between the location of the one or more vehicles and a staging location for the one or more accessory installation locations and a calculated cycle time to complete an accessory installation task associated with the one or more vehicles. The process of identifying the one or more vehicles may be based on other factors as well.

Once the one or more vehicles are identified, the task of retrieving the vehicle from the lot needs to be orchestrated. The allocation of a pull order corresponding to each of the at least one identified one or more vehicles to a puller may be based on one or more real-time metrics of the pullers. For example, the one or more real-time metrics may include a location of the puller, total task allocation assigned to the puller, a weighted average cycle time of the puller's completion efficiency or other metrics.

A pull order is generated and transmitted to a puller device of the puller. The pull order includes instructions to retrieve the one or more vehicles. For example the pull order may include a location of the one or more vehicles, a time to deliver each of the one or more vehicles to the staging location, and other information regarding the task.

The process improves the existing technology by incorporating and preserving the elements of Heijunka-based delivery logistics for operations with a moving conveyor line and cellular manufacturing at the same site that are interdependent to complete the vehicle manufacturing process. The process ensures that the operations have the optimal inventory to ensure that production runs at full capacity while minimizing overall cost and stockout. The process also recommends the amount of resources needed to support real time vehicle conveyance demand to production and improves cycle time calculation through advanced methods. Conformance to the pull requests are monitored in real time.

Determination of optimal queuing for vehicle accessory installation facilities has been hindered by the fact that the accessory installation facility may include both an endless line and a number of production bays. For example, vehicle options or accessories that require the vehicle to be lifted may be installed in a production bay. Such options or accessories include, but are not limited to, wheels, lock nuts, tires, brakes, exhaust systems, tow hitches, and others. In some cases, multiple production bays may exist for each type of vehicle accessory, such that, for example, five vehicles may receive wheel accessories simultaneously. Similarly, vehicle options or accessories that require access to the engine compartment, the vehicle exterior, or the vehicle interior may be installed on the conveyor line, which accepts vehicles one at a time. Such accessories include but are not limited to media systems, trim packages, floor mats, and headlights.

An additional complication is that the desired mix of vehicles at a dealership may not match the ordering of vehicles in the parking lot. For example, a particular dealership ordering sixteen vehicles may want three vehicles of Type A, three vehicles of Type B, and ten vehicles of Type C, whereas the next ten vehicles in a FIFO queue or hot calls from post-production accessory installation lines may be ten vehicles of Type A, which can generate further delays, as it takes longer to assemble the completed shipment of vehicles for that dealer. Optimal sequencing of the removal of vehicles from the queue must therefore include foreknowledge of the desired target mix of vehicles.

Because this heterogeneous mix of vehicles, accessories, and production resources vastly increases the number of possible queuing sequences, good methods do not currently exist for determining the optimal sequence in which to move queued vehicles from the parking lot to the conveyor line or a production bay. Additionally, in some instances, the optimal sequence, which is also referred to herein as a mixed model workflow plan, can be disrupted by deviations, such as a breakdown in a production bay, failure of human resources to showing up for work, and/or other issues that cause the mixed model workflow plan to be deviated from.

Various embodiments of the present disclosure include systems and methods for processing finished vehicles through the vehicle accessory installation process.

The present disclosure aids substantially in the production of motor vehicles, by improving the queuing, sequencing, and flow of vehicles on the shop floor of a production facility such as an accessory installation facility. Implemented on a mixed cellular and assembly line production facility whose machinery is in communication with one or more centralized processors, the vehicle production sequencing system disclosed herein provides practical improvements in the average time required to produce a vehicle, by improving the number of vehicles that can be customized in a work shift. This improved manufacturing process transforms a parking lot full of waiting vehicles into an orderly, optimized production queue, without the normal routine “starvation” and “overwhelm” of the assembly line as vehicles exit the production bays at different times. This unconventional approach improves the functioning of the accessory installation center, by ensuring that vehicles are moved into the production bays, and from there to the accessory installation location, in an optimized order that maximizes the number of vehicles produced in a shift.

The vehicle accessory installation system may be implemented as a process at least partially viewable on a display, and operated by a control process executing on a processor that accepts user inputs from a keyboard, mouse, or touchscreen interface, and that is in communication with one or more sensors, switches, etc. in the production bays and on the assembly line. In that regard, the control process performs certain specific operations in response to different inputs or selections made at different times and in response to different stimuli. Certain structures, functions, and operations of the processor, display, sensors, and user input systems are known in the art, while others are recited herein to enable novel features or aspects of the present disclosure with particularity.

These descriptions are provided for exemplary purposes only, and should not be considered to limit the scope of the vehicle accessory installation system. Certain features may be added, removed, or modified without departing from the spirit of the claimed subject matter.

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

The following will now describe embodiments of the systems and methods in more detail with reference to the drawings and where like numbers refer to like structures.

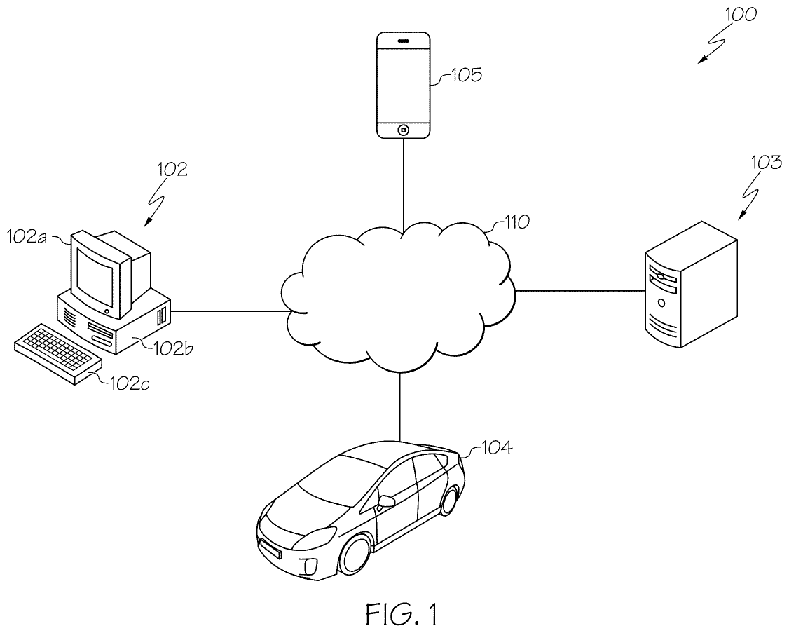

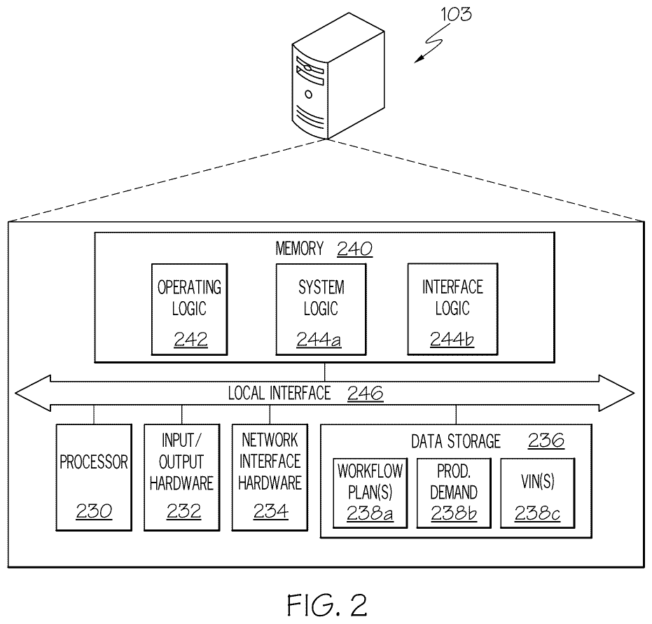

Referring to FIGS. 1-2, illustrative systems and computing devices for implementing processes for processing finished vehicles through the vehicle accessory installation according to embodiments of the present disclosure are depicted. In particular, FIG. 1 depicts one example system 100 implemented via a network 110 configured to perform processes of the present disclosure. The system 100 may include an interconnection of one or more devices, such as a computing device 102, a server 103, a vehicle 104, and a mobile device 105. The devices may be interconnected over a network 110. The network 110 may include a wide area network, such as the internet, a local area network (LAN), a mobile communications network, a public service telephone network (PSTN) and/or other network. In some embodiments, the network 110 may represent a peer-to-peer type network between devices. As used herein, a controller refers to any one of the computing device 102, the server 103, or the mobile device 105. In embodiments, the process for processing finished vehicles through the vehicle accessory installation process according to embodiments of the present disclosure may be implemented by one of the computing device 102, the server 103, or the mobile device 105, or a combination of the computing device 102, the server 103, or the mobile device 105.

The computing device 102 may include a display 102a, a processing unit 102b and an input device 102c, each of which may be communicatively coupled together and/or to the network 110. The computing device 102 may be a desktop computer, a server 103 or a mobile device 105, such as a personal computer, a laptop, a tablet, a smartphone, an application specification handheld device, or the like. The mobile device 105 may include an input device, such as a touch screen or keypad, and a display. The mobile device 105 may further include components such as a GPS for determining a location of the mobile device 105, an inertial measurement unit for measuring acceleration and angular velocity of the mobile device 105 along three mutually perpendicular axes. In some embodiments, the mobile device 105 may be implemented to track a puller's activities and/or plan pulling routes for the puller to deliver a vehicle from a parking lot to a production bay for finished vehicle accessory assembly activities.

The computing device 102 and/or the mobile device 105 may be used to enable the system 100 to access the CAN bus data from a vehicle 104 and/or for a puller to provide or receive information such as pull orders to and/or from the system 100. The system 100 may also include one or more servers 103. The server 103 may be configured to perform one or more process steps of the methods described herein. For example, but without limitation, the sever 103 may be configured to provide a web based application to a computing device 102 or a mobile device 105 of the user to prompt the user for information and/or access to the CAN bus data of a vehicle 104. In some embodiments, as described in more detail herein, the server 103 is configured to ingest a vehicle driving dataset, implement an artificial intelligence model or trained machine learning model to transform the mixed model workflow plan in response to a deviation occurrence. In certain embodiments, the server 103 may host a web based interface or an application that a user of a computing device 102 or mobile device 105 can access and interact with the process for processing vehicles through the vehicle accessory installation according to embodiments of the present disclosure.

The vehicle 104 may be an automobile, a watercraft, an airplane, a motor bike, a motor scooter, or the like.

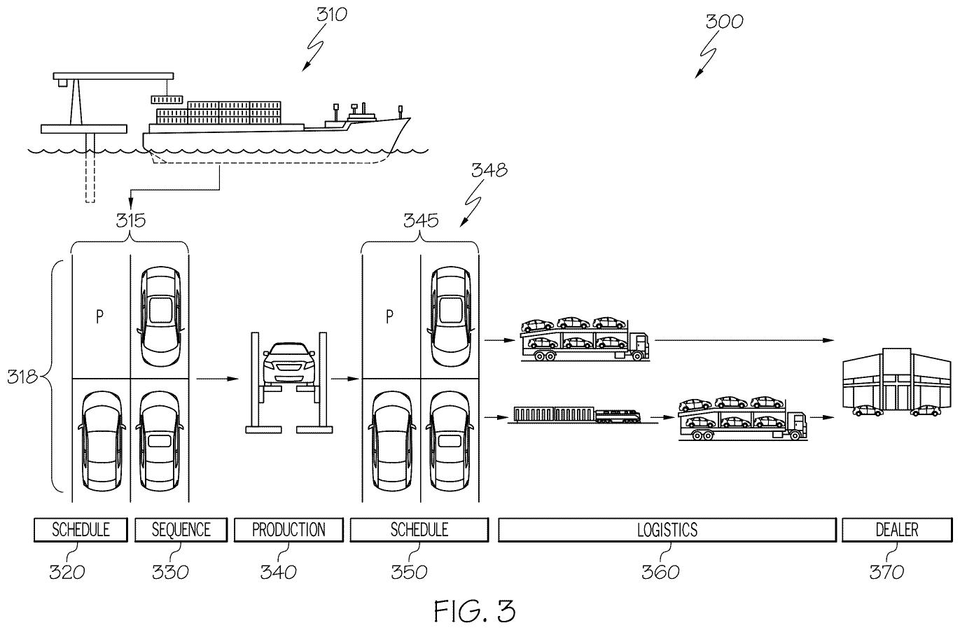

Turning to FIG. 2, an illustrative schematic of a computing device, such as a sever 103, according to the embodiments of the present disclosure. While FIG. 3 depicts the computing device as a server 103, it is understood that the processes described herein may be implemented on a computing device 102 or a mobile device 105. Moreover, it is understood that a server 103, a computing device 102 and/or a mobile device 105 may be implemented in the system 100 and execute one or more steps of the processes described herein. For purposes of explanation of the processes for processing vehicles through the vehicle accessory installation according to embodiments of the present disclosure, the processes are described with reference to implementation by a server 103.

In some embodiments, the server 103 includes one or more processors 230, input/output hardware 232, network interface hardware 234, a data storage component 236, which may store a vehicle driving dataset 238a, a database of refuel locations 238b, and/or fuel costs 238c searchable by type and/or location, and a memory component 240. The memory component 240, which may be one or more memories, may be machine readable memory (which may also be referred to as a non-transitory processor readable memory). The memory component 240 may be configured as volatile and/or nonvolatile memory and, as such, may include random access memory (including SRAM, DRAM, and/or other types of random access memory), flash memory, registers, compact discs (CD), digital versatile discs (DVD), and/or other types of storage components. Additionally, the memory component 240 may be configured to store operating logic 242, system logic 244a for implementing one or more of the methods described herein, and interface logic 244b for implementing one or more of the interactive interfaces described herein (each of which may be embodied as a computer program, firmware, or hardware, as an example).

A local interface 246 may be implemented as a bus or other interface to facilitate communication among the components of the controller.

The processor 230 may include any processing component(s) configured to receive and execute programming instructions (such as from the data storage component 236 and/or the memory component 240). The instructions may be in the form of a machine readable instruction set stored in the data storage component 236 and/or the memory component 240. The input/output hardware 232 may include a monitor, keyboard, mouse, printer, camera, microphone, speaker, and/or other device for receiving, sending, and/or presenting data. The network interface hardware 234 may include any wired or wireless networking hardware, such as a modem, LAN port, Wi-Fi card, WiMax card, mobile communications hardware, and/or other hardware for communicating with other networks and/or devices.

The data storage component 236 may reside local to and/or remote from the server 103 and may be configured to store one or more pieces of data for access by the computing device 102, the server 103, the vehicle 104, the mobile device 105 and/or other components. As illustrated in FIG. 2, the data storage component 236 may store mixed model workflow plan(s) 238a, production demand(s) 238b, and/or vehicle identification numbers 238 (VINs 238).

The mixed model workflow plan(s) 238a refers to workflow plans that organize the practice of assembling several distinct models of a product on the same assembly line without changeovers and then sequencing those models in a way that smoothens the demand for upstream components. The objective of the mixed model workflow plan(s) 238a is to smooth demand on upstream workcenters, manufacturing cells or suppliers and thereby reduce inventory, eliminate changeovers, improve kanban operation. However, these plans, from time-to-time may face complications that result in negative deviations that need to be addressed in real-time in order to continue to meet production demand for a time interval, such as a units per day delivery.

The production demand(s) 238b refers to delivery schedules and/or orders for time intervals. The VINs 238 refer to vehicles that are located in the parking lot and waiting for finished vehicle accessory installation processing. The VINs 238 may be further associated with specifications and/or other information.

FIG. 3 depicts a diagrammatic representation of a production logistics process 300 including the vehicle accessory installation process, in accordance with at least one embodiment of the present disclosure. In the example shown in FIG. 1, finished vehicles 315 are received at a port 310 or similar facility and delivered to a parking lot 318 or other queueing location. A production schedule 320 is computed for the finished vehicles 315, after which a sequence 330 is determined. For mixed cellular and line manufacturing facilities, the sequence is traditionally a FIFO queue, or hot calls from post-production accessory installation lines.

Based on the sequence 330, the finished vehicles 315 are moved into the production facility (e.g., an accessory installation facility), where they become fully accessorized vehicles 345, which are then delivered to a logistics holding area 348 (e.g., another parking lot), where a shipping schedule 350 determines their movement into a logistics process 360 where they are loaded onto trucks or trains for delivery to dealerships 370.

A primary chokepoint in the flow of finished vehicles 315 from the port 310 to the dealerships 370 is the amount of time the vehicles 315 spend in the production queue parking lot 318 and further the coordination of processing the vehicles 315 through the accessory installation facility. Thus, an object of the present disclosure is to provide systems and methods processing finished vehicles through the vehicle accessory installation process based on the orders placed by the dealerships 370.

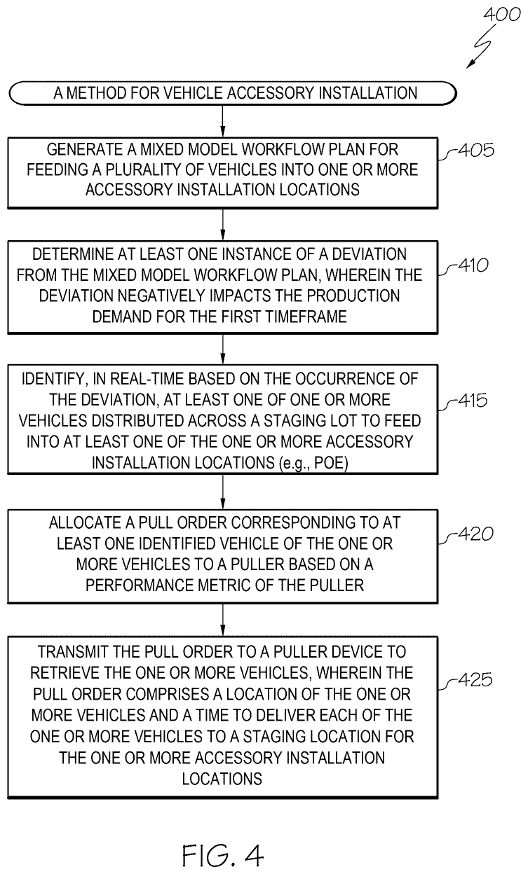

Methods processing finished vehicles through the vehicle accessory installation process, which may be implemented by the computing device, such as server 103, computing device 102, and/or the mobile device 105, will now be described in more detail with respect to the flow diagram depicted in FIG. 4.

Turning to FIG. 4, illustrative flow diagram 400 illustrates processing finished vehicles through the vehicle accessory installation process. In some embodiments, the vehicle accessory installation process includes supporting yard logistic operations for a finished vehicle accessory assembly operations that use a combination of both cellular and moving line operations. This assembly mix creates a unique challenge that other current processes have not addressed. In some embodiments, a weighted average cycle time and Heijunka planning method can support accessory installation methods throughout the production day.

At block 405, the vehicle accessory installation process includes generating a mixed model workflow plan for feeding a plurality of vehicles into one or more accessory installation locations. The vehicle accessory installation process may be implemented by a computing device, for example, a computing device described herein. The mixed model workflow plan defines a set of vehicles for processing through the accessory installation locations during a first timeframe. The mixed model workflow plan is generated from a production demand and order specifications for customized vehicles to be delivered to customers and/or dealers. The mixed model workflow plan takes into account the vehicles on the lot for customizing, the accessories available for install, the accessory installation locations, the resources, such as human capital, tools, and the like that are available, time to complete installs, and other production parameters. The mixed model workflow plan can be optimized to meet productivity, efficiency, and quality goals. The optimization may be achieved by utilizing Heijunka planning methods.

At block 410, the vehicle accessory installation process proceeds with determining at least one instance of a deviation from the mixed model workflow plan. In particular, deviations that negatively impact a production demand for a first timeframe need to be addressed in order to continue to meet the production demand. Since the negative impact is a result of the inability to continue to follow the mixed model workflow plan, adjustments to the plan are needed in real-time to keep up with the production demand for the first timeframe. Some examples, of deviations that negatively impact production demand may include slower than expected work, broken equipment, change in demand, production delays such as a delay in available parts for accessory installation, less human capital than in the plan, or the like.

At block 415, the vehicle accessory installation process proceeds with identifying, in real-time based on the occurrence of the deviation, at least one of one or more vehicles distributed across a staging lot to feed into at least one of the one or more accessory installation locations. For example, Port of Entry (POE) conveyance drivers may receive real-time pull instructions from a POE demand management system to deliver vehicles from a vessel unload area to pre-production staging lanes. As previously discussed, finished vehicles that arrive from manufacturing facilities are stored in parking lots until they can be processed through accessory installation. In addition to having parts available to finish the assembly of a vehicle, the distance the vehicles are located from the accessory installation locations adds a complexity to the mixed model workflow plan. As such, a puller needs to traverse a parking lot and then navigate the vehicle to the accessory installation location for completing the vehicle. That is, various accessory installation locations are configured to carry out specific operations.

In some embodiments, the step of identifying the one or more vehicles is based on: a distance between the location of the one or more vehicles and the staging location for the one or more accessory installation locations and a calculated cycle time to complete an accessory installation task associated with the one or more vehicles. In some instances, a puller may be directed to move a vehicle to an intermediate parking location, for example, move it from its original location to another location, that is optionally closer to the accessory installation locations, so that it may be closer when it is slotted for accessory installation. In some embodiments, the identifying the one or more vehicles is based on: a distance between the location of the one or more vehicles and the staging location for the one or more accessory installation locations and a proximity of the puller to the one or more vehicles. For example, as pullers carry out pulling task of relocating vehicles from their parking location to a staging lot for their respective accessory installation location, the pullers may be unevenly distributed through the parking lot.

At block 420, the vehicle accessory installation process proceeds with allocating a pull order corresponding to at least one identified vehicle of the one or more vehicles to a puller based on a performance metric of the puller. The process of allocating the pull order includes obtaining and analyzing profiles of the pullers. The profiles may include performance metric such a pull statistics, pull rates, and/or the like. Additionally, the current queue of each puller may also be considered. If a high performing puller has a large queue, then they may not be allocated a further pull order when other pullers are available.

In some embodiments, the step of allocating the pull order corresponding to the at least one identified vehicle of the one or more vehicles to the puller is further based on a proximity of the puller to the one or more vehicles. For example, pullers closer to an identified vehicle for pulling than another puller who is farther away. The location of each puller may be determined from a computing device such as a handheld device that the puller carries and interacts with the dispatcher through. The dispatcher may include a parking lot map that is continuously updated with positions of vehicles and locations of pullers. The computing device may be configured to automatically and continuously triangulate distances between vehicles and pullers within the parking lot.

At block 425, the vehicle accessory installation process proceeds with transmitting the pull order to a puller device to retrieve the one or more vehicles, wherein the pull order comprises a location of the one or more vehicles and a time to deliver each of the one or more vehicles to a staging location for the one or more accessory installation locations. The puller device may be a handheld device such as a smartphone, smart watch, or the like. The pull order may provide the puller with a VIN and/or other identification information of the vehicle that the pull order requests the puller to retrieve. In some embodiments, the pull order may include a map of the parking lot showing the puller where the vehicle is located. In some embodiments, the pull order may cause the puller device to lead the puller to the vehicle. This may be done through GPS signals or other homing and/or navigation techniques.

In a similar manner, once the puller locates the vehicle, the puller device may direct the puller to the staging location for the one or more accessory installation locations that the vehicle is to be delivered. In some embodiments, vehicles may be pulled in tandem. In such instances, the puller device may direct the puller to one or more additional vehicles to pick-up and delivery to the respective staging locations for the one or more accessory installation locations.

The vehicle accessory installation process may continue to evaluate whether the mixed model workflow plan is being followed and whether there are any deviations that negatively impact the plan. When there are negative impacts, the vehicle accessory installation process is configured to intervene and reconfigure the mixed model workflow plan so that production demand may continue to be met in light of a negative deviation.

It should be understood that embodiments of the present disclosure are directed to systems and methods for processing finished vehicles through the vehicle accessory installation process. More specifically, embodiments provide techniques for orchestrating adjustments to a vehicle accessory installation workflow plan in real-time when a deviation from the workflow plan occurs. The techniques utilize elements of Heijunka, such as mix, leveling, and balance along with optimization and visual controls for human resource and delivery equipment. Implementation of embodiments described herein may result in an improvement in total output, the balance and leveling of production lines, full work for team members, and an increase in the total number of dealers serviced each day.

The functional blocks and/or flowchart elements described herein may be translated onto machine-readable instructions. As non-limiting examples, the machine-readable instructions may be written using any programming protocol, such as: (i) descriptive text to be parsed (e.g., such as hypertext markup language, extensible markup language, etc.), (ii) assembly language, (iii) object code generated from source code by a compiler, (iv) source code written using syntax from any suitable programming language for execution by an interpreter, (v) source code for compilation and execution by a just-in-time compiler, etc. Alternatively, the machine-readable instructions may be written in a hardware description language (HDL), such as logic implemented via either a field programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components.

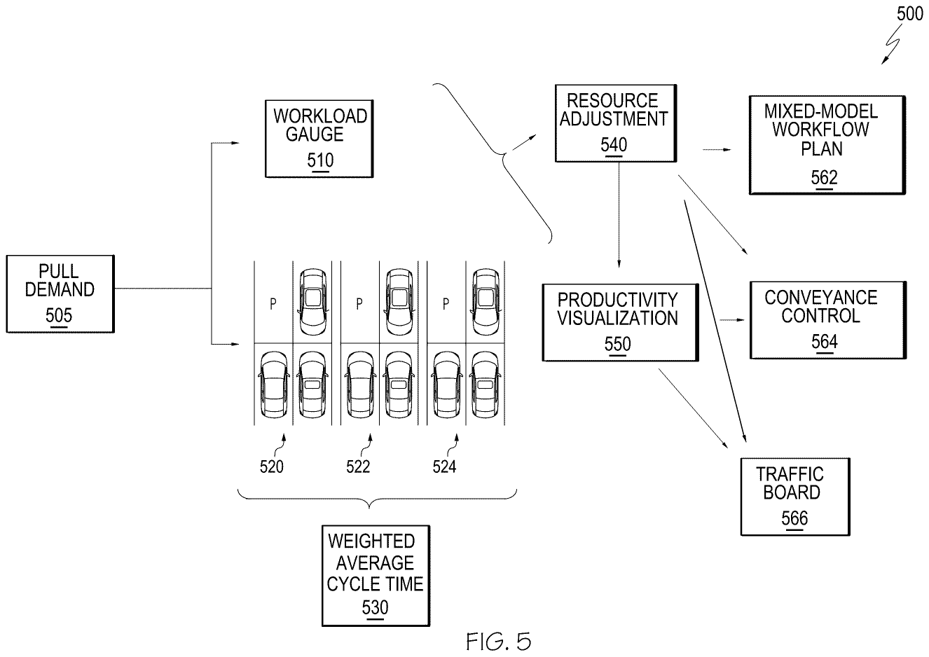

In some embodiments, a demand management process may include the method for processing finished vehicles through the vehicle accessory installation process. FIG. 5 depicts an illustrative block diagram of the demand management process for processing finished vehicles through the vehicle accessory installation process. At block 505, a pull demand may be defined and input into the demand management process. The pull demand may define one or more pull orders corresponding to vehicles for final vehicle accessory installation. Pull demand may include a list of multiple vehicles.

The pull demand from block 505 may be fed into both a workload gauge block 510 and a cycle time block 530. The workload gauge block 510 includes one or processes that calculates the workload needed to handle the pull demand 505.

In the cycle time block 530, cycle time to complete an accessory installation task associated with the one or more vehicles located at various locations (e.g., section 520, section 522, and 524) may be calculated. The weighted average cycle time may be determined based on a cycle time multiplied by a demand percentage for a section divided by the total demand.

The workload from the workload gauge block 510 and the weighted average cycle time from the workload gauge block 510 may be fed into a resource adjustment block 540. The resource adjustment block 540 may be configured to adjust the resources to carry out the pull orders defined by the pull demand. The resource adjustment block 540 may also receive changes to the pull orders that may occur in response to insufficient resources, new requests for accessory installation tasks, or other event that changes the pull demand.

The resource adjustment block 540 may feed one or more additional blocks. For example, productivity visualizations may be generated at block 550. In some embodiments, the resource adjustment block 540 may feed a mixed-model workflow plan block 562 causing the mixed-model workflow plan to be updated based on the input from the resource adjustment block 540. In some embodiments, the resource adjustment block 540 may feed a conveyance control block 564. The conveyance control block 564 may include software and hardware that causes pullers to be allocated to pull orders so that the pull orders are fulfilled.

In further embodiments, resource adjustment block 540 and/or block 550 may enable updates to a traffic board at block 566 that tracks the traffic related to vehicles moving from a storage locations (e.g., section 520, 522, 524) through staging and accessory installation.

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” For example, reference to an element (e.g., “a processor,” “a controller,” “a memory,” etc.), unless otherwise specifically stated, should be understood to refer to one or more elements (e.g., “one or more processors,” “one or more controllers,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. A method for vehicle accessory installation comprising:
generating a mixed model workflow plan for feeding a plurality of vehicles into one or more accessory installation locations;
determining at least one instance of a deviation from the mixed model workflow plan, wherein the deviation negatively impacts a production demand for a first timeframe;
identifying, in real-time based on the occurrence of the deviation, at least one of one or more vehicles distributed across a staging lot to feed into at least one of the one or more accessory installation locations;
allocating a pull order corresponding to at least one identified vehicle of the one or more vehicles to a puller based on a performance metric of the puller; and
transmitting the pull order to a puller device to retrieve the one or more vehicles, wherein the pull order comprises a location of the one or more vehicles and a time to deliver each of the one or more vehicles to a staging location for the one or more accessory installation locations.

2. The method of claim 1, wherein the deviation includes at least one of a reduction in planned human capital, an equipment failure, or a delay in available parts for accessory installation.

3. The method of claim 1, wherein the performance metric comprises a pull rate for the puller.

4. The method of claim 1, wherein the step of identifying the one or more vehicles is based on: a distance between the location of the one or more vehicles and the staging location for the one or more accessory installation locations and a calculated cycle time to complete an accessory installation task associated with the one or more vehicles.

5. The method of claim 1, wherein the step of identifying the one or more vehicles is based on: a distance between the location of the one or more vehicles and the staging location for the one or more accessory installation locations and a proximity of the puller to the one or more vehicles.

6. The method of claim 1, wherein the mixed model workflow plan is devised to achieve the production demand for the first timeframe.

7. The method of claim 1, wherein the step of allocating the pull order corresponding to the at least one identified vehicle of the one or more vehicles to the puller is further based on a proximity of the puller to the one or more vehicles.

8. A system for vehicle accessory installation, the system comprising:
a processor; and
a memory storing computer-executable instructions that, when executed by the processor, cause the system to:
generate a mixed model workflow plan for feeding a plurality of vehicles into one or more accessory installation locations;
determine at least one instance of a deviation from the mixed model workflow plan, wherein the deviation negatively impacts a production demand for a first timeframe;
identify, in real-time based on the occurrence of the deviation, at least one of one or more vehicles distributed across a staging lot to feed into at least one of the one or more accessory installation locations;
allocate a pull order corresponding to at least one identified vehicle of the one or more vehicles to a puller based on a performance metric of the puller; and
transmit the pull order to a puller device to retrieve the one or more vehicles, wherein the pull order comprises a location of the one or more vehicles and a time to deliver each of the one or more vehicles to a staging location for the one or more accessory installation locations.

9. The system of claim 8, wherein the deviation includes at least one of a reduction in planned human capital, an equipment failure, or a delay in available parts for accessory installation.

10. The system of claim 8, wherein the performance metric comprises a pull rate for the puller.

11. The system of claim 8, wherein to identify the one or more vehicles is based on: a distance between the location of the one or more vehicles and the staging location for the one or more accessory installation locations and a calculated cycle time to complete an accessory installation task associated with the one or more vehicles.

12. The system of claim 8, wherein to identify the one or more vehicles is based on: a distance between the location of the one or more vehicles and the staging location for the one or more accessory installation locations and a proximity of the puller to the one or more vehicles.

13. The system of claim 8, wherein the mixed model workflow plan is devised to achieve the production demand for the first timeframe.

14. The system of claim 8, wherein to allocate the pull order corresponding to the at least one identified vehicle of the one or more vehicles to the puller is further based on a proximity of the puller to the one or more vehicles.

15. A non-transitory computer-readable medium comprising processor-executable instructions that, when executed by one or more processors of an apparatus, causes the apparatus to perform a method comprising:
generating a mixed model workflow plan for feeding a plurality of vehicles into one or more accessory installation locations, wherein the mixed model workflow plan is devised to achieve the production demand for a first timeframe;
determining at least one instance of a deviation from the mixed model workflow plan, wherein the deviation negatively impacts a production demand for the first timeframe;
identifying, in real-time based on the occurrence of the deviation, at least one of one or more vehicles distributed across a staging lot to feed into at least one of the one or more accessory installation locations;
allocating a pull order corresponding to at least one identified vehicle of the one or more vehicles to a puller based on a performance metric of the puller; and
transmitting the pull order to a puller device to retrieve the one or more vehicles, wherein the pull order comprises a location of the one or more vehicles and a time to deliver each of the one or more vehicles to a staging location for the one or more accessory installation locations.

16. The non-transitory computer-readable medium of claim 15, wherein the deviation includes at least one of a reduction in planned human capital, an equipment failure, or a delay in available parts for accessory installation.

17. The non-transitory computer-readable medium of claim 15, wherein the performance metric comprises a pull rate for the puller.

18. The non-transitory computer-readable medium of claim 15, wherein the step of identifying the one or more vehicles is based on: a distance between the location of the one or more vehicles and the staging location for the one or more accessory installation locations and a calculated cycle time to complete an accessory installation task associated with the one or more vehicles.

19. The non-transitory computer-readable medium of claim 15, wherein the step of identifying the one or more vehicles is based on: a distance between the location of the one or more vehicles and the staging location for the one or more accessory installation locations and a proximity of the puller to the one or more vehicles.

20. The non-transitory computer-readable medium of claim 15, wherein the step of allocating the pull order corresponding to the at least one identified vehicle of the one or more vehicles to the puller is further based on a proximity of the puller to the one or more vehicles.
